(19) United States
(12) Patent Application Publication
(10) Pub. No.: US 2014/0347345 A1
(43) Pub. Date: Nov. 27, 2014

(54) CIRCUIT AND TELEVISION APPARATUS

(71) Applicant: KABUSHIKI KAISHA TOSHIBA, Tokyo (JP)

(72) Inventor: Yoshiaki Yoshizawa, Hiki-gun (JP)

(73) Assignee: KABUSHIKI KAISHA TOSHIBA, Tokyo (JP)

(21) Appl. No.: 14/151,659

(22) Filed: Jan. 9, 2014

(30) Foreign Application Priority Data
May 21, 2013 (JP) 2013-107339

(51) Int. Cl. G09G 5/18; G09G 3/36

(52) U.S. Cl. CPC G09G 5/18; G09G 3/36
USPC 345/213; 345/99

(57) ABSTRACT

According to one embodiment, a circuit includes: a synchronous driver configured to generate a control signal in synchronization with an output pulse of an AC/DC converter; and an LED current controller configured to start to control a current of an LED in response to the control signal, and configured to output a stop signal for stopping the control signal when a predetermined LED current is detected; wherein the synchronous driver is caused to stop the control signal by the stop signal.

### CROSS REFERENCE TO RELATED APPLICATION(S)

The application is based upon and claims the benefit of priority from Japanese Patent Application No. 2013-107339 filed on May 21, 2013, the entire contents of which are incorporated herein by reference.

### BACKGROUND

1. Field

The present invention relates to a circuit and a television apparatus.

2. Description of the Related Art

In the field of a liquid crystal TV (Television) or the like, for example, there is a demand for an LED-driver integrated power supply.

FIG. 7 shows an example of a usual conventional circuit. In a conventional LED-driver integrated power supply, a pulse output of an AC/DC converter 1 is rectified by a rectifying circuit 2, and the DC voltage is supplied to a DC/DC converter 3. The DC/DC converter 3 controls the output voltage so that the loss of a constant-current controlling circuit 4 is reduced. The LED current is voltage-converted and fed back by a detection resistor 5, and subjected to a constant-current control.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a diagram showing an embodiment of the invention, and illustrating an example of a network system which is mainly configured by a digital television broadcast receiver;

FIG. 2 is a block diagram showing a signal process system which is a main component of the digital television broadcast receiver of the embodiment;

FIG. 3 is a block diagram showing an example of an image display device which is incorporated in the digital television broadcast receiver of the embodiment;

FIG. 4 is a basic circuit diagram showing an example of the embodiment;

FIG. 5 is an operational waveform chart of the embodiment;

FIG. 6 is a circuit diagram showing an example of another embodiment; and

FIG. 7 is a diagram showing an example of a conventional circuit.

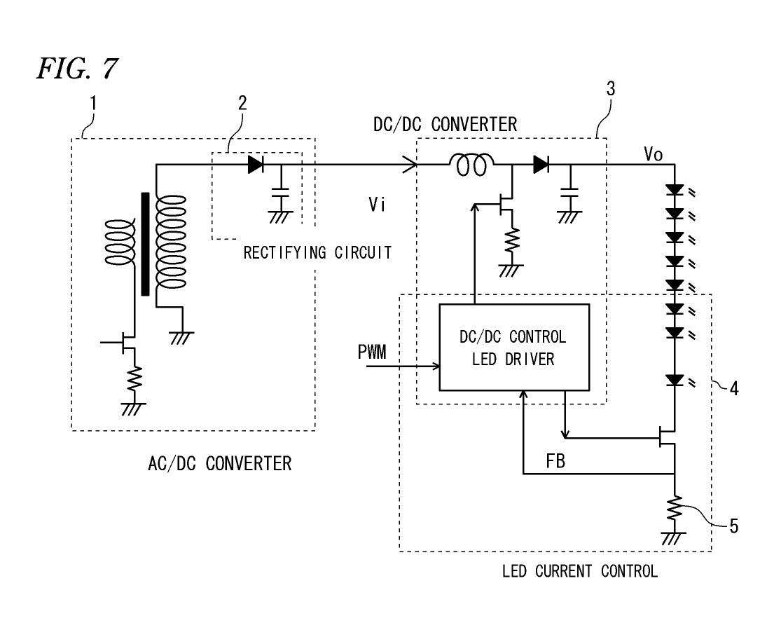

### DETAILED DESCRIPTION

According to one embodiment, a circuit includes: a synchronous driver configured to generate a control signal in synchronization with an output pulse of an AC/DC converter; and an LED current controller configured to start to control a current of an LED in response to the control signal, and configured to output a stop signal for stopping the control signal when a predetermined LED current is detected; wherein the synchronous driver is caused to stop the control signal by the stop signal.

Hereinafter, embodiments will be described.

### First Embodiment

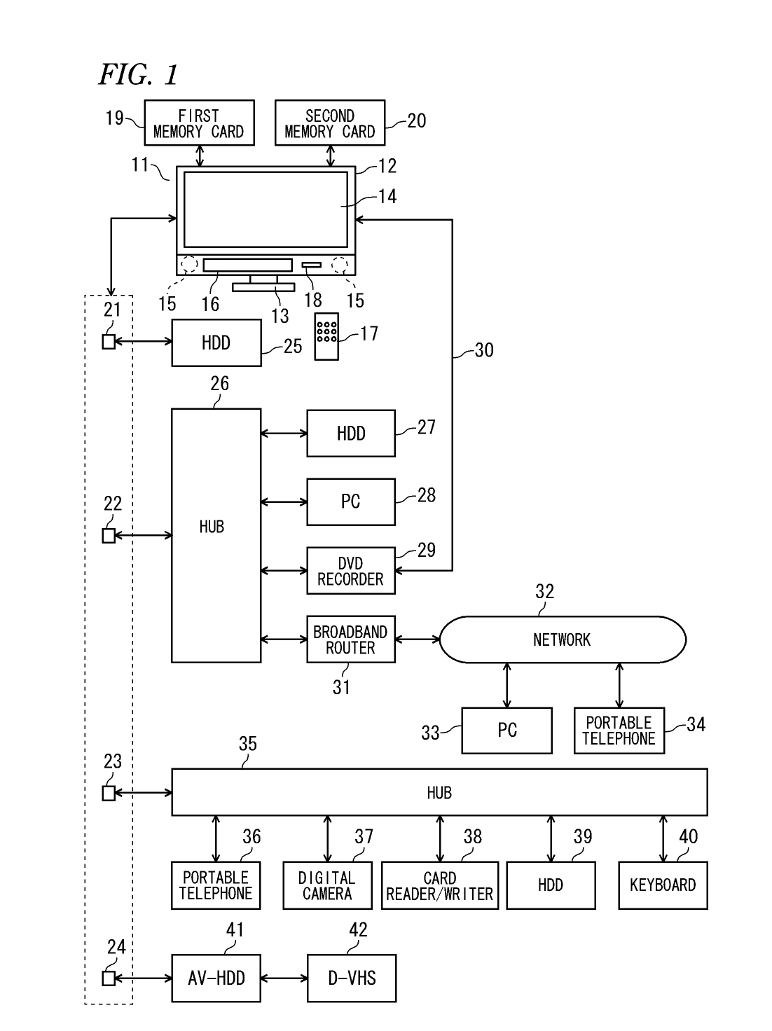

A first embodiment will be described with reference to FIGS. 1 to 5. FIG. 1 schematically shows the appearance of a digital television broadcast receiver 11 which will be described as a television apparatus of the embodiment, and an example of a network system which is mainly configured by the digital television broadcast receiver.

The digital television broadcast receiver 11 is mainly configured by a thin cabinet 12 and a support table 13 which uprightly supports the cabinet 12. In the cabinet 12, disposed are an image display device 14 which is a flat panel display device including a liquid crystal display panel and the like, a pair of speakers 15, an operator 16, a light receiver 18 which receives operation information transmitted from a remote controller 17, and the like.

A first memory card 19 such as an SD (Secure Digital) memory card, an MMC (Multimedia Card), or a memory stick is detachably attached to the digital television broadcast receiver 11. Information such as programs and photographs is recorded on and reproduced from the first memory card 19.

Moreover, a second memory card [IC (Integrated Circuit) card] 20 on which, for example, contract information is recorded is detachably attached to the digital television broadcast receiver 11. The contract information is reproduced from the second memory card 20.

The digital television broadcast receiver 11 further includes a first LAN (Local Area Network) terminal 21, a second LAN terminal 22, a USB (Universal Serial Bus) terminal 23, and an IEEE (Institute of Electrical and Electronics Engineers) 1394 terminal 24.

Among the terminals, the first LAN terminal 21 is used as a port dedicated for a LAN-compatible HDD. The first LAN terminal is used for recording and reproducing information on and from a connected LAN-compatible HDD (Hard Disk Drive) 25 which is a NAS (Network Attached Storage), through Ethernet (registered trademark).

As described above, by the provision of the first LAN terminal 21 as a port dedicated for a LAN-compatible HDD, the recording of information of programs with a Hi-Vision image quality can be stably performed on the HDD 25 without being affected by the other network environments and the usage conditions of the network.

The second LAN terminal 22 is used as a general-purpose LAN-compatible port using Ethernet (registered trademark). The second LAN terminal is connected via, for example, a hub 26 to apparatuses such as a LAN-compatible HDD 27, a PC (Personal Computer) 28, and a DVD (Digital Versatile Disk) recorder 29 with a built-in HDD having a function of receiving digital broadcasting, and used for performing information transmission with these apparatuses.

With respect to the DVD recorder 29, the digital information transmitted via the second LAN terminal 22 is only the information of a control system. In order to transmit analog image and audio information with the digital television broadcast receiver 11, therefore, it is required to dispose a dedicated analog transmission path 30.

The second LAN terminal 22 is connectable to a network 32 such as Internet via a broadband router 31 connected to the hub 26, and is used for performing information transmission with a PC 33, portable telephone 34, and the like which are placed in remote places, via the network 32.

The USB terminal 23 is used as a general-purpose USB-compatible port. The USB terminal is connected via a hub 35 to USB apparatuses such as a portable telephone 36, a digital camera 37, a card reader/writer 38 for a memory card, an HDD 39, and a keyboard 40, and used for performing information transmission with these USB apparatuses.

The IEEE 1394 terminal 24 is serially connected to an AV (Audio Video)—HDD 41, a D (Digital)—VHS (Video Home System) 42, and the like each of which has a digital broadcast receiving function, and used for performing information transmission with these apparatuses.

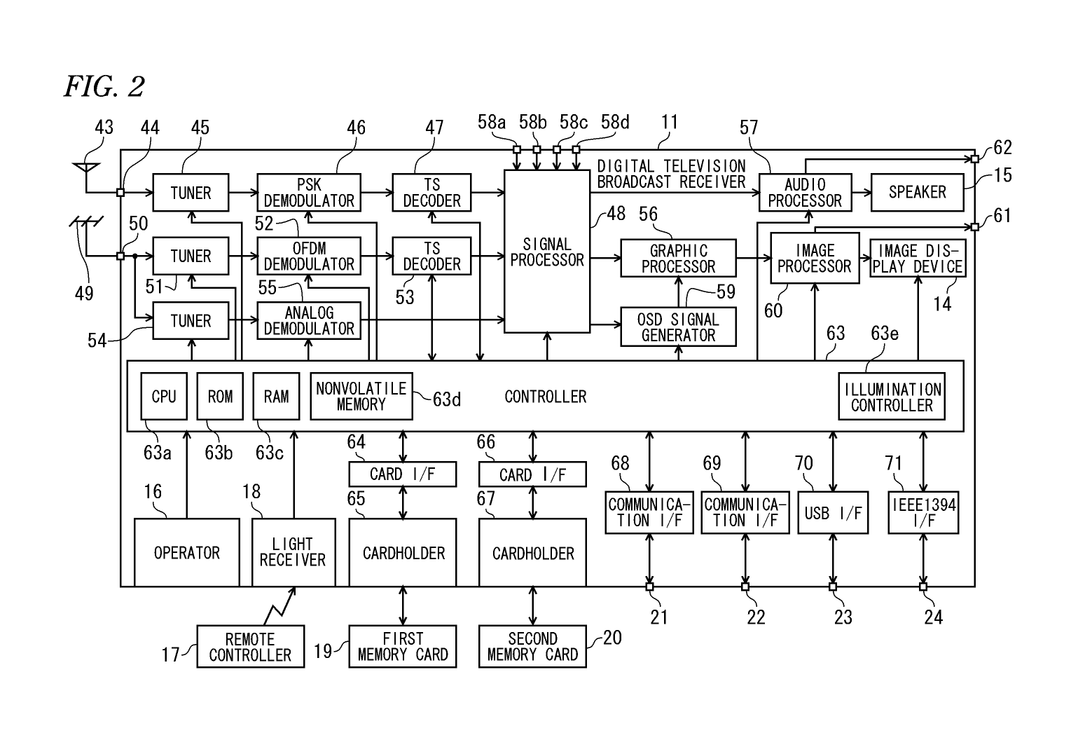

FIG. 2 shows the main signal processing system of the above-described television broadcast receiver 11. Specifically, a satellite digital broadcast signal received through an antenna 43 for receiving digital BS (Broadcasting Satellite)/CS (Communication Satellite) broadcasting is supplied to a tuner 45 for satellite digital broadcasting via an input terminal 44, whereby a broadcast signal of a desired channel is tuned.

The broadcast signal tuned by the tuner 45 is supplied to a PSK (Phase Shift Keying) demodulator 46, so that TS (Transport Stream) is demodulated. The TS is supplied to a TS decoder 47 to be decoded into a digital image signal, a digital audio signal, and the like. Thereafter, the decoded signals are supplied to a signal processor 48.

A terrestrial digital television broadcast signal received by an antenna 49 for receiving terrestrial broadcasting is supplied to a tuner 51 for terrestrial broadcasting via an input terminal 50, whereby a broadcast signal of a desired channel is tuned.

The broadcast signal tuned by the tuner 51 is supplied to an OFDM (Orthogonal Frequency Division Multiplexing) demodulator 52, so that TS is demodulated. The TS is supplied to a TS decoder 53, so that the TS is decoded into a digital image signal and a digital audio signal. Thereafter, the decoded signals are supplied to the signal processor 48.

A terrestrial digital television broadcast signal received by the antenna 49 for receiving terrestrial broadcasting is supplied to a tuner 54 for terrestrial broadcasting via the input terminal 50, whereby a broadcast signal of a desired channel is tuned. The broadcast signal tuned by the tuner 54 is supplied to an analog demodulator 55 to be demodulated an analog image signal and an analog audio signal. Thereafter, the demodulated signals are supplied to the signal processor 48.

The signal processor 48 selectively performs a predetermined digital signal process on the digital image and audio signals respectively supplied from the TS decoders 47, 53, and supplies the processed signals to a graphic processor 56 and an audio processor 57.

A plurality (in the illustrated example, four) of input terminals 58a, 58b, 58c, 58d are connected to the signal processor 48. The input terminals 58a to 58d enable analog image and audio signals to be input from the outside of the digital television broadcast receiver 11.

The signal processor 48 selectively digitizes the analog image and audio signals respectively supplied from the analog demodulator 55 and the input terminals 58a to 58d, performs a predetermined digital signal process on the digitized image and audio signals, and then supplies the processed signals to the graphic processor 56 and the audio processor 57.

The graphic processor 56 has a function of superimposing an OSD (On Screen Display) signal generated by an OSD signal generator 59, on the digital image signal supplied from the signal processor 48, and outputting the resulting signal. The graphic processor 56 can selectively output one of the output image signal of the signal processor 48 and the output OSD signal of the OSD signal generator 59, and alternatively can output both of the output signals in a combination manner in which each of them constitutes a half of the screen.

The digital image signal output from the graphic processor 56 is supplied to an image processor 60. The image processor 60 converts the input digital image signal into an analog image signal of a format which can be displayed by the image display device 14. Thereafter, the analog image signal is supplied to the image display device 14 to be displayed as an image, and further supplied to the outside via an output terminal 61.

The audio processor 57 converts the input digital audio signal into an analog audio signal in a format which can be reproduced by the speakers 15. Thereafter, the analog audio signal is supplied to the speakers 15 to be reproduced as sound, and further supplied to the outside via an output terminal 62.

In the television broadcast receiver 11, all of the operations thereof including the above-described various receiving operations are generally controlled by a controller 63. The controller 63 incorporates a CPU (Central Processor) 63a, and receives operation information from the operator 16, or receives operation information which is transmitted from the remote controller 17 to be received by the light receiver 18, so that the respective modules are controlled so as to reflect the operation contents.

In this case, the controller 63 mainly utilizes a ROM (Read Only Memory) 63b for storing control programs which are to be executed by the CPU 63a, a RAM (Random Access Memory) 63c for providing a working area for the CPU 63a, and a nonvolatile memory 63d in which various setting information, control information, and the like are stored.

The controller 63 is connected to a cardholder 65 to which the first memory card 19 can be attached, via a card I/F (Interface) 64. Accordingly, the controller 63 can perform information transmission with the first memory card 19 attached to the cardholder 65, through the card I/F 64.

In addition, the controller 63 is connected to a card holder 67 to which the second memory card 20 can be attached, via a card I/F 66. Accordingly, the controller 63 can perform information transmission with the second memory card 20 attached to the cardholder 67, through the card I/F 66.

The controller 63 is connected to the first LAN terminal 21 via a communication I/F 69. Accordingly, the controller 63 can perform information transmission with the LAN-compatible HDD 25 connected to the first LAN terminal 21, through the communication I/F 68. In this case, the controller 63 has a DHCP (Dynamic Host Configuration Protocol) server function, and controls the LAN-compatible HDD 25 connected to the first LAN terminal 21 while assigning an IP (Internet Protocol) address to the HDD.

In addition, the controller 63 is connected to the second LAN terminal 22 via a communication I/F 69. Accordingly, the controller 63 can perform information transmission with the various apparatuses (see FIG. 1) connected to the second LAN terminal 22, through the communication I/F 69.

The controller 63 is connected to the USB terminal 23 via a USB I/F 70. Accordingly, the controller 63 can perform information transmission with the various apparatuses (see FIG. 1) connected to the USB terminal 23, through the USB I/F 70.

Moreover, the controller 63 is connected to the IEEE 1394 terminal 24 via an IEEE 1394 I/F 71. Accordingly, the controller 63 can perform information transmission with the various apparatuses (see FIG. 1) connected to the IEEE1394 terminal 24, through the IEEE 1394 I/F 71.

The controller 63 includes an illumination controller 63e. Although described in detail later, the illumination controller 63e has a function of performing a so-called illumination control on a backlight of the image display device 14 to make variable the brightness of the illumination light to be emitted from the backlight.

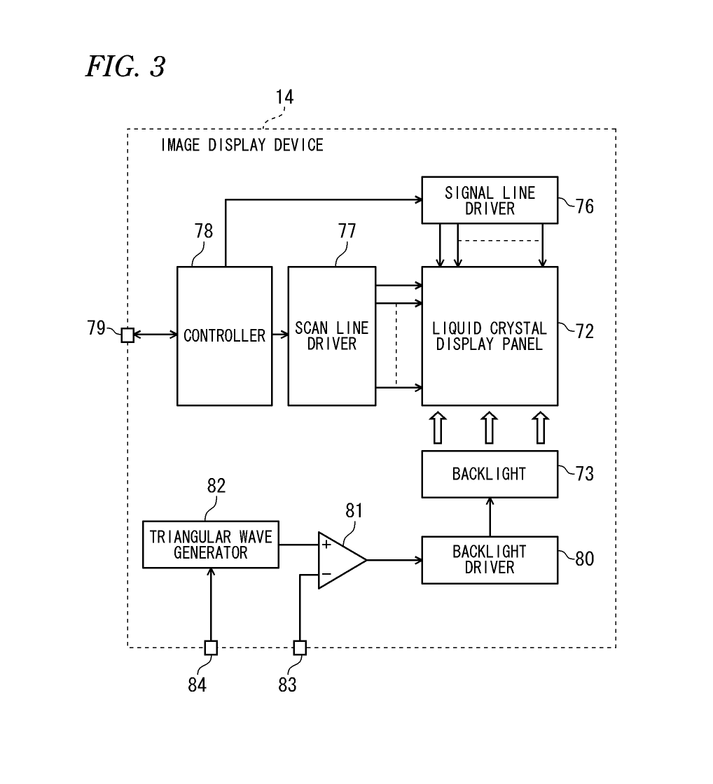

FIG. 3 shows an example of the image display device 14. The image display device 14 includes a liquid crystal display panel 72 which forms a display image based on an image signal output from the image processor 60, and the backlight 73 which illuminates the liquid crystal display panel 72 from the back face side to display an image.

As shown in FIG. 3, a signal line driver 76 which supplies an image signal while switching from one to another one of horizontal lines, and a scan line driver 77 which supplies a progressive scan line driving signal are connected to the liquid crystal display panel 72.

The operations of the signal line driver 76 and the scan line driver 77 are generally controlled by a controller 78. The image signal output from the image processor 60 is supplied to the controller 78 via an input terminal 79. The controller 78 correspondingly controls the timing when the scan line driver 77 supplies the progressive scan line driving signal, and that when the signal line driver 76 supplies the image signal supplied to the input terminal 79, while switching from one to another one of the horizontal lines.

The backlight 73 is conventionally configured by a cold-cathode tube such as a fluorescent tube or a discharge lamp. Recently, the backlight is configured by LEDs or the like. The backlight 73 is controlled selectively to a turn-ON state or a turn-OFF state, by a supply of a backlight driving signal supplied from a backlight driver 80.

In this case, the backlight driver 80 produces the backlight driving signal to be supplied to the backlight 73, based on a PWM (Pulse Width Modulation) signal output from a level comparator 81.

In the level comparator 81, a triangular wave signal which is output from a triangular wave generator 82, and which has a constant frequency is supplied to the positive (+) input terminal, and a threshold level which is input from the illumination controller 63e of the controller 63 via an input terminal 83 is supplied to the negative (−) input terminal.

It is assumed that the triangular wave signal is supplied to the positive (+) input terminal of the level comparator 81, and the threshold level to the negative (−) input terminal of the level comparator 81. Then, the level comparator 81 outputs the PWM signal which, when the level of the triangular wave signal is equal to or higher than the threshold level, is at the H (High) level, and, when the level of the triangular wave signal is lower than the threshold level, is at the L (Low) level. The period of the PWM signal is equal to the refresh rate of the liquid crystal display panel 72, and, for example, 120 Hz.

The backlight driver 80 to which the PWM signal is supplied generates the backlight driving signal which, during the H-level period of the PWM signal, is an AC (for example, 50 to 100 kHz) driving signal having a predetermined p-p (peak to peak) level, and which, during the L-level period of the PWM signal, has a 0 level, and supplies the signal to the backlight 73.

During the period when the AC driving signal is supplied, the backlight 73 is in the turn-ON state, and, during the period when the 0-level driving signal is supplied, in the turn-OFF state. In this case, the backlight 73 is intermittently turned ON. Because of the integration effect, however, the human eyes sense that the backlight is continuously turned ON.

When the threshold level output from the illumination controller 63e of the controller 63 is made variable, therefore, it is possible to control the ratio of the H-level period of the PWM signal to the L-level period. Accordingly, the ratio of the turn-ON period of the backlight 73 to the turn-OFF period can be changed, and the illumination control with respect to the backlight is enabled.

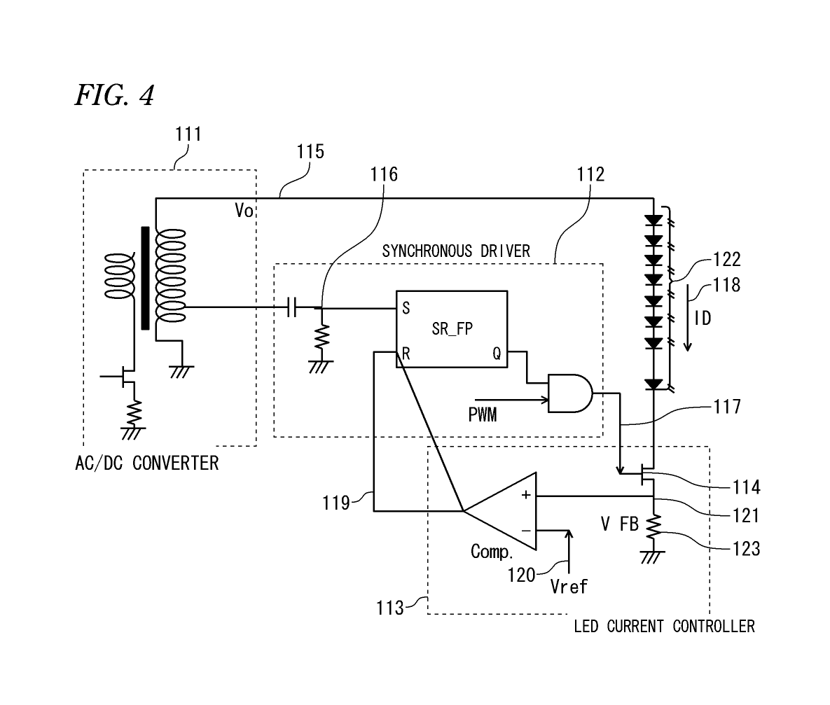

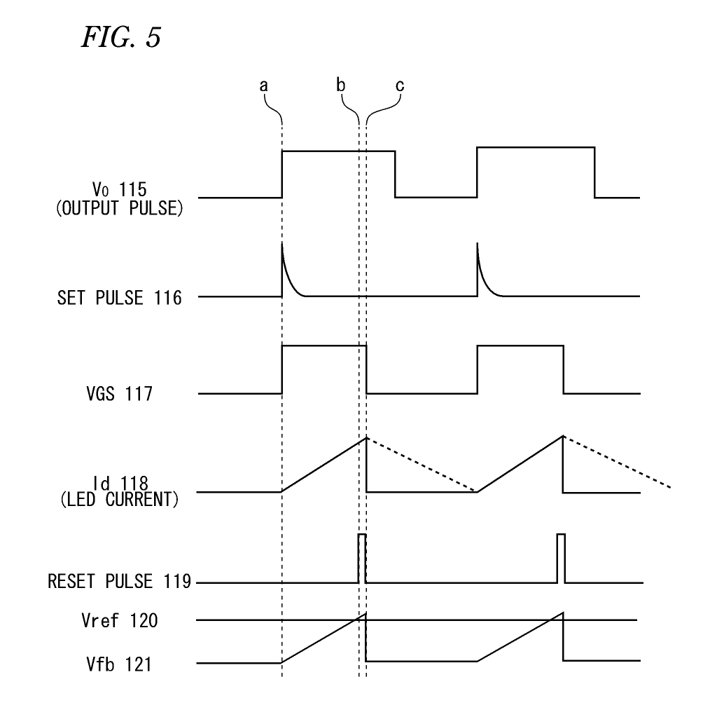

FIG. 4 shows an example (basic circuit configuration) of a circuit which mainly consists of the backlight driver 80 and the backlight 73 (LEDs). The example is roughly configured by an AC/DC converter 111, a synchronous driver 112, and an LED current controller 113. The output pulse 115 of the AC/DC converter 111 is directly connected to LEDs 122 without passing through a rectifying circuit, and the LED current Id 118 which is synchronized with the AC/DC converter 111 is controlled by a switching FET 114. The other components will be described with reference to FIG. 5 below.

FIG. 5 shows operation waveforms of main portions of FIG. 4. The ordinate shows the arrangement of the modules, and the abscissa indicates the time transition. The output pulse 115 is generated as a driving signal V₀ having a period of, for example, about 50 to 100 kHz. At this time, a DC power is supplied from a commercial power supply or the like to the AC/DC converter 111 through a diode stack and smoothing capacitor which are not shown.

The driving signal V₀ is differentiated by a CR circuit disposed in the input stage of the synchronous driver 112, and formed as a set pulse 116 which rises at the rising timing a of the driving signal V₀.

The set pulse 116 sets a set/reset flip-flop SR_FP with the result that, when the PWM signal is at the H level, a VGS signal 117 is set to ON.

As a result, an FET 114 in the LED current controller 113 is conductive, and the LED current Id 118 is increased. Then, a reset pulse 119 is produced by a comparator at a timing b (for example, the current reaches 1 A) when a voltage VFB 121 generated by a resistor 123 (for example, 1 Ω) exceeds a reference voltage Vref 120 (for example, 1 V). This causes the flip-flop SR_FP to be reset at a timing c which is slightly later than the timing b.

The reset operation causes the VGS signal 117 to be set to OFF, so that the FET 114 is nonconductive, the LED current Id 118 does not flow, and the voltage VFB 121 drops. As a result, the whole circuit returns to the state which is attained before the rising timing a of the driving signal V₀. Each time when the rising timing a of the driving signal V₀ again occurs, these operations are repeated (synchronously with the AC/DC converter 111).

### Second Embodiment

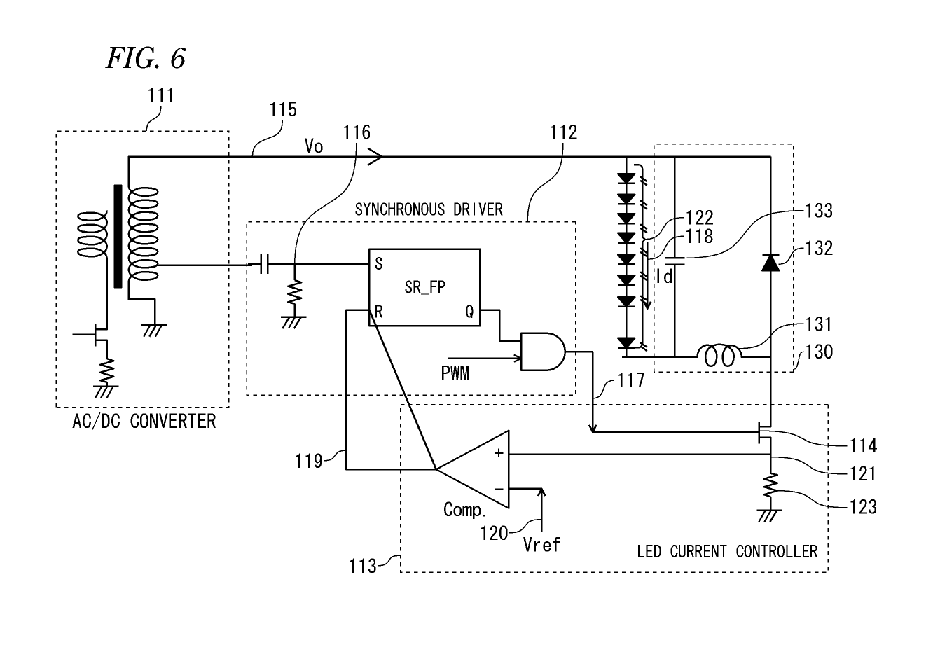

A second embodiment will be described with reference to FIGS. 4 and 6. Description of components which are common to the first embodiment will be omitted. FIG. 6 is a circuit diagram showing an example of the embodiment.

In the first embodiment, the LED current Id is discontinuous. When a coil 131, a diode 132, and a capacitor 133 are added as a current maintainer 130, the LED current Id can be made continuous (the current can be prevented from being suddenly interrupted). The module may be configured so that, from the timing c, charges stored in the capacitor 133 functioning as a capacitance circulate through the diode 132 with a time constant which is determined by the capacitor and the coil 131 functioning as a reactance, as indicated by the broken lines in FIG. 5.

When the LED current Id is made continuous, the average current of the LEDs can be increased although several components must be added as compared with the first embodiment. This leads to an effect of suppressing the peak current of the LEDs, and other effects.

In the above, the VA effects of the LED-driver integrated power supply which is to be employed in a liquid crystal television apparatus or the like have been described. The LED current is directly pulse-driven by the output pulse of the AC/DC converter, thereby enabling a rectifying circuit, a DC/DC converter, and a Class-A constant current circuit to be omitted. This is because the output pulse of the AC/DC converter is synchronized with the pulse driving of the LED current, and the control element for the LED current is connected in series to the LEDs to perform the switching operation.

Namely, effects of the cost reduction due to the omission of a rectifying circuit, a DC/DC converter, and a constant current circuit (including a narrowly defined driver), and the improvement of the power supply efficiency (by the change of the method of controlling the LED current, the DC/DC conversion loss, and the switching loss due to rectification are suppressed, and the efficiency of the whole circuit is improved) are attained. Furthermore, the substrate area is expected to be reduced by simplification of the circuit.

The invention is not limited to the above-described embodiments, and may be embodied while variously modified without departing the spirit of the invention.

By appropriate combinations of plural components disclosed in the above-described embodiments, various inventions may be configured. For example, some of the components may be omitted from all of the components shown in the embodiments. Moreover, the components in different embodiments may be appropriately combined.

What is claimed is:

1. A circuit comprising:
a synchronous driver configured to generate a control signal synchronized with an output pulse of an AC/DC converter; and
an LED current controller configured to control a current of an LED in response to the control signal, and configured to output a stop signal for stopping the control signal when a first LED current is detected; wherein
the synchronous driver is configured to stop the control signal by the stop signal.

2. The circuit according to claim 1, wherein
the circuit further comprises a current maintainer configured to maintain the LED current.

3. The circuit according to claim 1, wherein
the current controller comprises a comparator configured to output the stop signal when a voltage generated by the LED current exceeds a reference voltage.

4. The circuit according to claim 1, wherein
the circuit further comprises the LED.

5. The circuit according to claim 1, wherein
the circuit further comprises the AC/DC converter.

6. A television apparatus comprising:
a display panel configured to display a display image based on an image signal;
an illuminator configured to illuminate the display panel with illumination light to cause the display panel to display the display image; and
an illumination controller configured to control a brightness of the illumination light to be emitted from the illuminator, based on a result of a level comparison between a triangular wave signal of a constant frequency and a threshold level, wherein:
the illumination controller comprises: a circuit comprising: a synchronous driver configured to generate a control signal synchronized with an output pulse of an AC/DC converter; and an LED current controller configured to control a current of an LED in response to the control signal, and configured to output a stop signal for stopping the control signal when a first LED current is detected; and
the synchronous driver is configured to stop the control signal by the stop signal.
